(19) United States
(12) Patent Application Publication
(10) Pub. No.: US 2011/0265590 A1
(43) Pub. Date: Nov. 3, 2011

(54) GEAR AND TRANSMSSION MECHANISM USING THE SAME

(75) Inventor: BO LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/954,860

(22) Filed: Nov. 27, 2010

(30) Foreign Application Priority Data
Apr. 28, 2010 (CN) 201010157963.4

(51) Int. Cl. F16H 35/08

(52) U.S. Cl. 74/400

(57) ABSTRACT

A gear includes an outer gear ring, an inner gear ring, and one or more elastic members. The inner gear ring engages the outer gear ring. The inner gear ring forms one or more sliding portions. The outer gear ring defines one or more sliding grooves receiving the sliding portions. The elastic members are positioned in the sliding grooves. The sliding portions are received in the sliding grooves, and resist the elastic members. A transmission mechanism using the gear is also provided.

### BACKGROUND

1. Technical Field

The present disclosure relates generally to drive systems and, more particularly, to bevel gears and a transmission mechanism using the same.

2. Description of Related Art

Gears are widely used in transmission mechanisms. A commonly used transmission mechanism includes an input shaft and an output shaft connected by a plurality of gears of different sizes, such that the input shaft and the output shaft can rotate at different speed.

A gear generally includes a cylindrical main body and a gear portion extending from an end of the main body. The main body defines a connecting hole receiving the input shaft or the output shaft. The gear portions of the gears used in the transmission mechanism mesh with each other.

However, the gears are easily abraded after a long service life, thus a gap is generated between two adjacent gears. Therefore, a transmission precision of the transmission mechanism is decreased.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of an embodiment of a transmission mechanism, including a transmission shaft, a first gear, a second gear, a washer, and a blocking member.

FIG. 2 is an exploded, isometric view of the transmission mechanism of FIG. 1.

FIG. 3 is a cross-section of the transmission mechanism of FIG. 1, taken along the line III-III.

FIG. 4 is a cross-section of the transmission mechanism of FIG. 1, taken along the line IV-IV.

FIG. 5 is a plan view of the first gear of FIG. 1.

### DETAILED DESCRIPTION

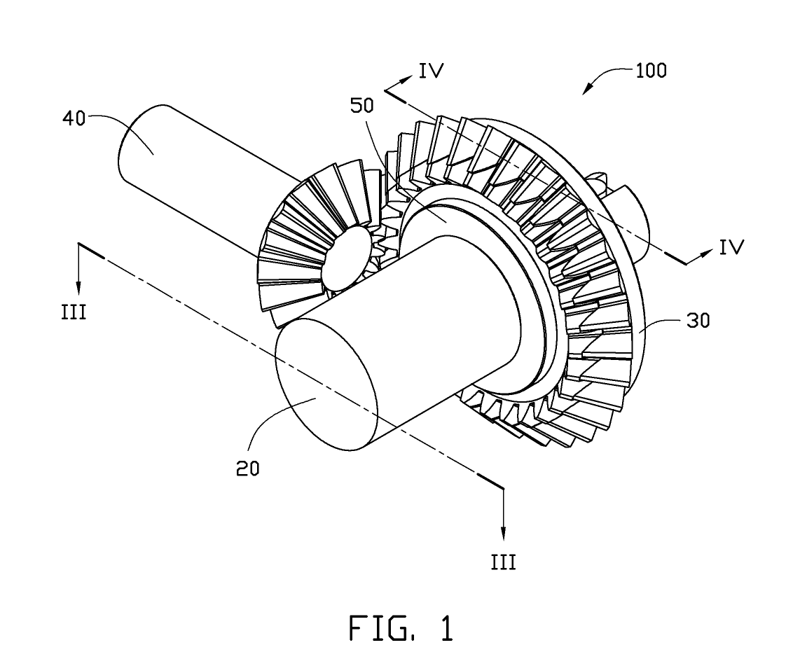

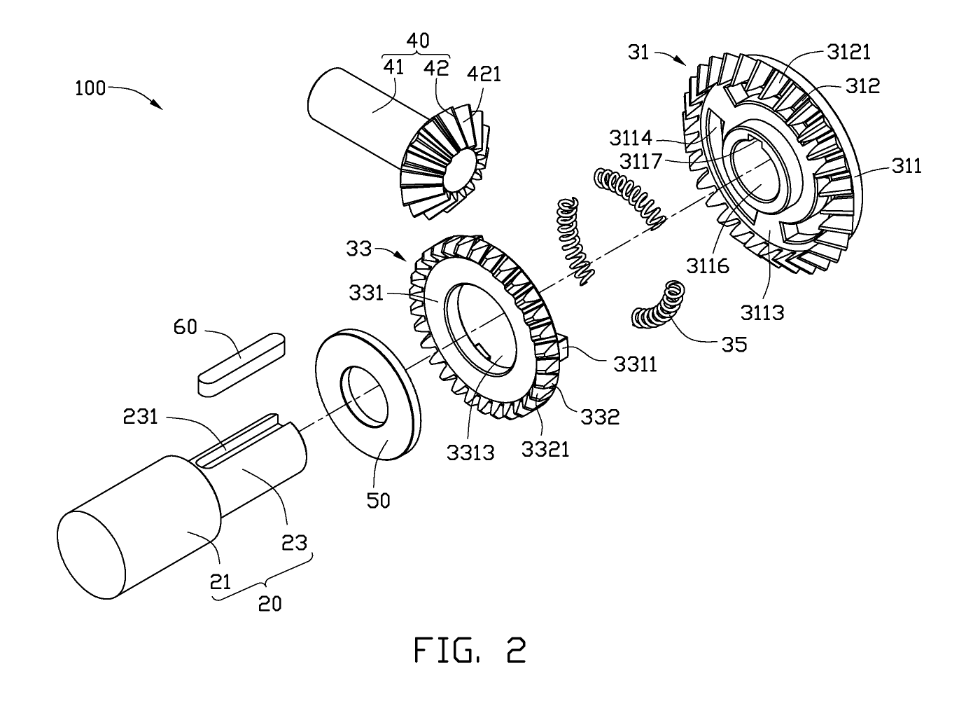

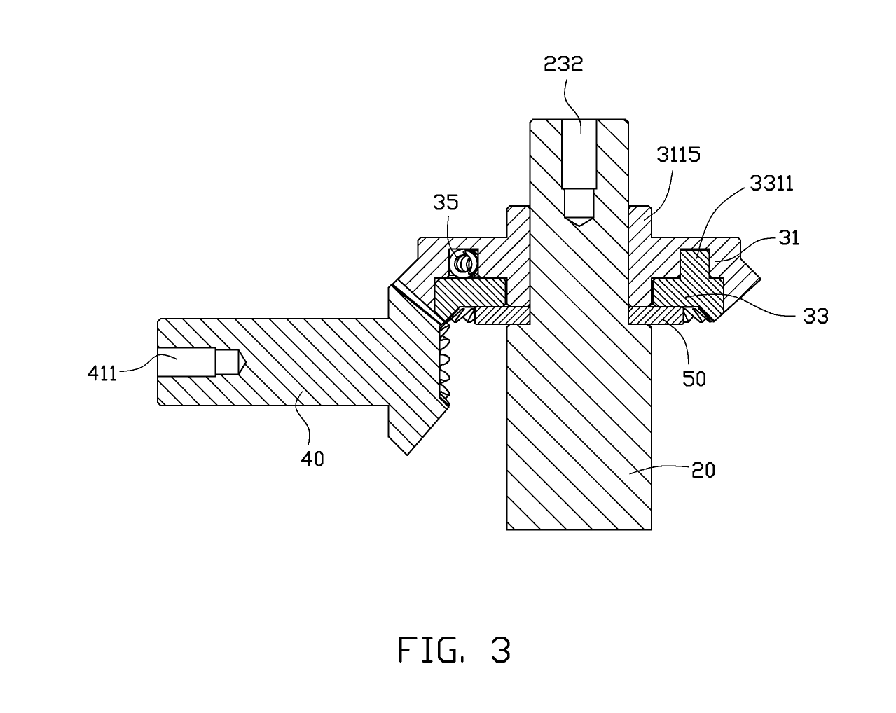

Referring to FIGS. 1 through 3, an embodiment of a transmission mechanism 100 includes a transmission shaft 20, a first gear 30, a second gear 40, a washer 50, and a blocking member 60. The first gear 30 and the washer 50 are sleeved on the transmission shaft 20. The second gear 40 meshes with the first gear 30. The blocking member 60 is positioned between the transmission shaft 20 and the first gear 30.

The transmission shaft 20 includes a cylindrical shaft body 21 and a connecting portion 23 extending from an end of the shaft body 21. A diameter of the connecting portion 23 is less than that of the shaft body 21. The connecting portion 23 defines a receiving groove 231 in the side surface partially receiving the blocking member 60. The connecting portion 23 further defines a first assembly hole 232 in an end surface.

The first gear 30 includes an outer gear ring 31, an inner gear ring 33, and three elastic members 35 positioned between the outer gear ring 31 and the inner gear ring 33.

The outer gear ring 31 includes a cylindrical first main body 311 and a first gear portion 312 extending from an edge of the first main body 311. The first gear portion 312 includes a plurality of first gear teeth 3121 along the periphery. The first main body 311 defines an assembly groove 3113 in a first surface (not labeled) receiving the inner gear ring 33. A bottom wall in the assembly groove 3113 further defines a plurality of curved sliding grooves 3114 evenly arranged in the first main body 311. In the illustrated embodiment, the first main body 311 defines three sliding grooves 3114. The first main body 311 further forms an engaging portion 3115 in the center of a second surface (not labeled) opposite to the first surface. The first main body 311 defines a connecting hole 3116 therein. A sidewall defining the connecting hole 3116 axially defines an engaging groove 3117.

The inner gear ring 33 includes a cylindrical second main body 331 and a second gear portion 332 extending from an edge of the second main body 331. The main body 331 defines a pivot hole 3313. The second gear portion 332 includes a plurality of second gear teeth 3321 along the periphery. The second main body 331 forms a plurality of sliding portions 3311 evenly arranged and surrounding the pivot hole 3313. In the illustrated embodiment, the second main body 331 forms three sliding portions 3311.

In the illustrated embodiment, the elastic members 35 are compression springs, which are received in the curved sliding grooves 3114 of the first main body 311.

The second gear 40 includes a pivot shaft 41 and a third gear portion 42 formed at an end of the pivot shaft 41. An end of the pivot shaft 41 away from the gear portion 42 defines a second assembly hole 411. The third gear portion 42 includes a plurality of third gear teeth 421 along the periphery.

In assembly of the transmission mechanism 100, the washer 50 is sleeved on the connecting portion 23. The blocking member 60 is partially received in the receiving groove 231 of the connecting portion 23. The connecting portion 23 of the transmission shaft 20 extends through the inner gear ring 33, the outer gear ring 31, and the blocking member 60 is partially received in the engaging groove 3117 of the outer gear ring 31. The elastic members 35 are positioned in the sliding grooves 3114 of the first main body 311. The inner gear ring 33 is received in the assembly groove 3113 of the outer gear ring 31 with the sliding portions 3311 received in the sliding grooves 3114 of the outer gear ring 31. The first gear teeth 3121 and the second gear teeth 3321 are then individually aligned with each other.

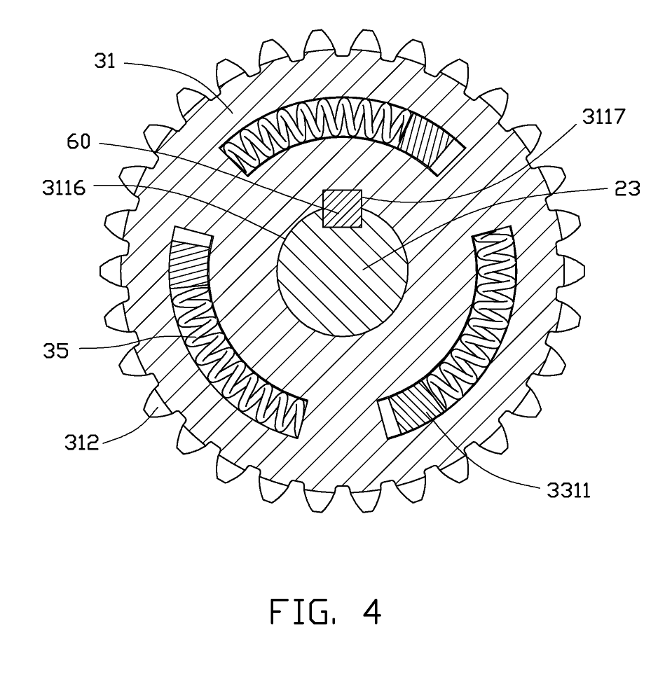

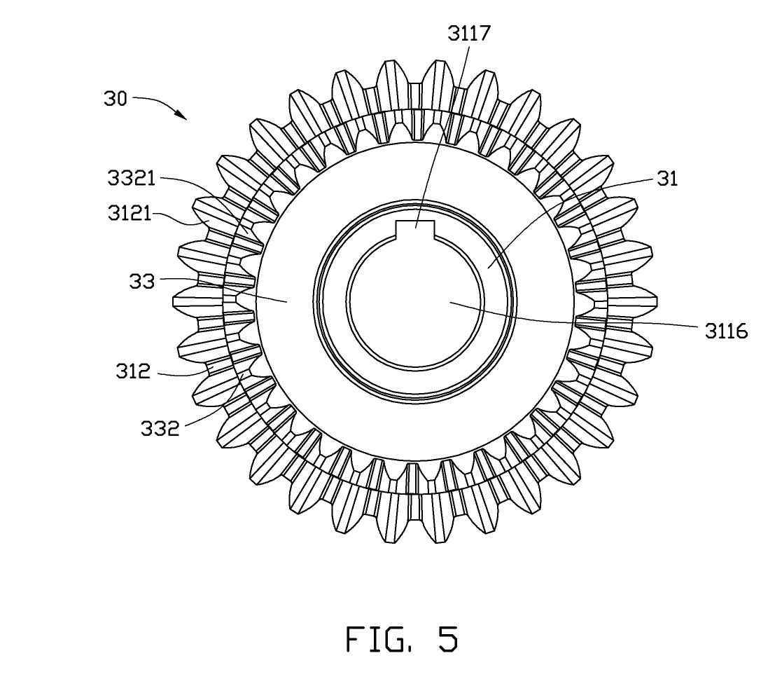

Referring also to FIGS. 4 and 5, in use, the transmission shaft 20 can be connected to other components via the first assembly hole 232, and the second gear 40 can be connected to other components via the second assembly hole 411. When the transmission shaft 20 rotates, the first gear 30 is rotated by the transmission shaft 20, and the second gear 40 is rotated by the first gear 30. When a gap forms between the first gear 30 and the second gear 40 after time, the sliding portions 3311 of the inner gear ring 33 slide in the sliding grooves 3114 of the outer gear ring 31 by a meshing force between the outer gear ring 31 and the inner gear ring 33. Simultaneously, the elastic members 35 are compressed by the sliding grooves 3114 (see FIG. 4). In other words, the inner gear ring 33 rotates through an angle relative to the outer gear ring 31, thus the second gear teeth 3321 of the inner gear ring 33 deviate from the first gear teeth 3121 by an angle (see FIG. 5). Thus, one first gear tooth 3121 and one corresponding second gear tooth 3321 can respectively resist two adjacent third gear teeth 421 of the second gear 40. As a result, the gap between the first gear 30 and the second gear 40 is eliminated, and the effective life of the transmission mechanism 100 is prolonged.

It should be appreciated that the sliding portions 3311 may be formed on the outer gear ring 31, with the inner gear ring 33 correspondingly defining sliding grooves 3114 receiving the sliding portions 3311. The outer gear ring 31 may also only define one sliding groove 3114, and the inner gear ring 33 correspondingly form one sliding portion 3311. The sliding groove 3114 can be other shapes, such as a longitudinal groove, as long as the inner gear ring 33 can slide relative to the outer gear ring 31.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A gear, comprising:
an outer gear ring;
an inner gear ring engaging with the outer gear ring, wherein one of the outer gear ring and the inner gear ring forms at least one sliding portion, and the other one of the outer gear ring and the inner gear ring defines at least one sliding groove receiving the at least one sliding portion; and
at least one elastic member positioned in the at least one sliding groove, wherein the at least one sliding portion resists the at least one elastic member.

2. The gear of claim 1, wherein the outer gear ring defines a plurality of sliding grooves evenly arranged in the outer gear ring.

3. The gear of claim 1, wherein the at least one sliding groove is at least one curved sliding groove.

4. The gear of claim 1, wherein the outer gear ring comprises a first main body and a first gear portion extending from an edge of the first main body.

5. The gear of claim 4, wherein the first gear portion includes a plurality of first gear teeth along the periphery.

6. The gear of claim 5, wherein the inner gear ring comprises a second main body and a second gear portion extending from an edge of the second main body.

7. The gear of claim 6, wherein the second gear portion includes a plurality of second gear teeth along the periphery corresponding to the plurality of first gear teeth.

8. The gear of claim 4, wherein the first main body defines a connecting hole.

9. The gear of claim 8, wherein a sidewall defining the connecting hole axially defines an engaging groove.

10. A transmission mechanism, comprising:
a transmission shaft;
a first gear sleeved on the transmission shaft, the first gear comprising:
an outer gear ring;
an inner gear ring engaging with the outer gear ring, wherein one of the outer gear ring and the inner gear ring forms at least one sliding portion, the other one of the outer gear ring and the inner gear ring defines at least one sliding groove receiving the at least one sliding portion; and
at least one elastic member positioned in the at least one sliding groove, wherein the at least one sliding portion resists the at least one elastic member; and
a second gear meshed with the first gear.

11. The transmission mechanism of claim 10, wherein the transmission shaft comprises a shaft body and a connecting portion extending from an end of the shaft body, and the first gear is sleeved on the connecting portion.

12. The transmission mechanism of claim 11, further comprising a washer sleeved on the connecting portion and between the first gear and the shaft body.

13. The transmission mechanism of claim 10, further comprising a blocking member, wherein the transmission shaft defines a receiving groove, the outer gear ring defines an engaging groove, and the blocking member is partially received in the receiving groove of the transmission shaft and the engaging groove of the outer gear ring.

14. The transmission mechanism of claim 10, wherein the outer gear ring defines a plurality of sliding grooves evenly arranged in the outer gear ring.

15. The transmission mechanism of claim 10, wherein the at least one sliding groove is at least one curved sliding groove.

16. The transmission mechanism of claim 10, wherein the outer gear ring comprises a first main body and a first gear portion extending from an edge of the first main body.

17. The transmission mechanism of claim 16, wherein the first gear portion includes a plurality of first gear teeth along the periphery.

18. The transmission mechanism of claim 17, wherein the inner gear ring comprises a second main body and a second gear portion extending from an edge of the second main body.

19. The transmission mechanism of claim 18, wherein the second gear portion includes a plurality of second gear teeth along the periphery corresponding to the plurality of first gear teeth.
